(19) United States
(12) Patent Application Publication
(10) Pub. No.: US 2005/0276452 A1
(43) Pub. Date: Dec. 15, 2005

(54) 2-D to 3-D facial recognition system

(76) Inventor: James Michael Boland, New York, NY (US)

Correspondence Address: James M. Boland;#1R, 267 W 90th St., New York, NY, 10024, US

(21) Appl. No.: 10/703,615

(22) Filed: Nov. 7, 2003

Related U.S. Application Data
(60) Provisional application No. 60/424,816, filed on Nov. 12, 2002.

(51) Int. Cl. G06K 9/00

(52) U.S. Cl. 382/118; 382/181; 382/154

(57) ABSTRACT

A system and method of recognizing human faces by converting a two-dimensional (2D) Facial image into three-dimensions (3D) and subsequently using a Facial Recognition System to identify the individual in the original 2D image. The 3D image may also be processed in a variety of ways so as to broaden the recognition of the individual in the original 2D image.

### REFERENCES CITED

### U.S. PATENT DOCUMENTS

| | | |
|---|---|---|
| 4,573,191 | February 1986 | Kidode, et al |
| 4,575,722 | March 1986 | Anderson |
| 4,821,118 | April 1989 | Lafreniere |
| 4,980,762 | December 1990 | Heeger, et at |
| 5,012,522 | April 1991 | Lambert |
| 5,028,994 | July 1991 | Miyakawa |
| 5,107,444 | April 1992 | Wu |
| 5,105,466 | April 1992 | Tsujiuchi, et at. |
| 5,164,992 | November 1992 | Turk, et at |
| 5,255,352 | October 1993 | Falk |
| 5,283,644 | February 1994 | Maeno |
| 5,432,543 | July 1995 | Hasegawa, et at |
| 5,432,864 | July 1995 | Lu, et al |
| 5,469,512 | November 1995 | Fujita, et at |
| 4,935,810 | February 1996 | Nonami, et at |
| 5,510,832 | April 1996 | Garcia |
| 5,550,928 | August 1996 | Lu, et at |
| 5,739,844 | April 1998 | Kuwano, et at |
| 5,995,119 | November 1999 | Cosatto, et at |
| 5,995,639 | November 1999 | Kado, et at |
| 6,147,692 | November 2000 | Shaw, et at |
| 6,606,096 | August 2003 | Wang |

### BACKGROUND OF THE INVENTION

1. Field of the Invention

The present invention relates generally to Facial Recognition and more specifically to recognizing human faces from 2D images.

2. Description of the Related Art

It can be appreciated that Facial Recognition Systems have been in use for many years. Typically, 2D Facial Recognition Systems have relied on a single 2D image of the face being presented to and subsequently processed to produce a unique mathematical value to identify the individual. This process is generally referred to as Enrollment or being enrolled.

Recently Facial Recognition Systems use a series of 2D facial images on the x, y and z axes to enroll an individual into the Facial Recognition System.

More recently 3D cameras have been employed to create a 3D image that is used to enroll an individual.

As Facial Recognition Systems that utilize 3D images and multiple (x, y, and z) 2D images of individuals as the basis of enrollment can identify a face from many angles, they are widely regarded as a more effective method of Facial Recognition.

It can also be appreciated that 2D image to 3D image conversion systems have been in use for many years. They take 2D images of individuals' faces and convert them into a 3D image that represents the appearance of the original individual.

It can also be appreciated that the 3D images created from 2D may be further manipulated to simulate different lighting conditions, shadows, aging, facial hair, weight loss, weight gain and other facial expressions by the same 2D to 3D Image Conversion System. These systems are widely used in the entertainment and computer graphics industries.

The main problem is that many individuals who are required to be recognized by Facial Recognition Systems currently exist only in 2D images. These 2D images in some instances may have been taken some time before and may not represent how the individual appears today.

A problem with 2D to 3D Image Conversion Systems is that they do not identify individuals' faces.

Another problem is that although a 2D image may be enrolled into a Facial Recognition System, the Facial Recognition system can only identify the individual if they subsequently present from the same perspective of the original 2D image. If the individual subsequently presents from multiple perspectives on the x, y and x axes, the Facial Recognition System will in most cases fail to recognize the individual, thus rendering them ineffective.

Another problem with Facial Recognition Systems is that they do not convert existing 2D images to 3D, nor can they generate different lighting conditions, shadows, aging, facial hair, weight loss, weight gain and other facial expressions.

While these Facial Recognition Systems and 2D to 3D Image Conversion Systems may be suitable for the particular purpose to which they address, they are not independently capable of uniquely identifying human faces from multiple angles in different lighting conditions, shadows, aging, facial hair, weight loss, weight gain, eyeglasses and other facial expressions from a 2D image.

In these respects, the existing 2D to 3D Facial Recognition System according to the present invention substantially departs from the conventional concepts and designs of the prior art, and in so doing provides a system primarily developed for the purpose of converting 2D images into 3D and subsequently recognizing human faces.

### SUMMARY OF THE INVENTION

In view of the foregoing disadvantages inherent in the known types of 2D to 3D Image Conversion Systems and Facial Recognition Systems not present in the prior art, the present invention provides a new 2D to 3D Facial Recognition System wherein the same can be utilized for identifying human faces from 2D images converted into 3D.

The general purpose of the present invention, which will be described subsequently in greater detail, is to provide a new 2D to 3D Facial Recognition System that has many of the advantages of 2D to 3D Image Conversion Systems and Facial Recognition Systems hereforeto and many novel features that result in a new 2D to 3D Facial Recognition System which is not anticipated, rendered obvious, suggested, or even implied by any of the prior art Facial Recognition Systems, or 2D to 3D Image Conversion Systems either alone or in any combination thereof.

To attain this, the present invention generally comprises of one or more electronic devices with one or more connected cameras. The camera is comprised of a device capable of capturing images either in black and white or color or any light frequency from infra red to ultra violet. The 2D image (x and y axex) to 3D image conversion system capable of converting 2D images into 3D (x, y and z).

The Facial Recognition System is capable of identifying individuals from multiple angles of a human face generally provided by a camera. The electronic device is comprised of either a single or multi-processor machine (or machines) such as, but not limited to, a computer capable of performing the 2D to 3D image conversion and the facial recognition.

The process consists of generating a 3D image of a human face from a 2D image of a human face and using the 3D facial image, or multiple perspectives or aspects thereof, as the basis for enrollment in Facial Recognition System.

There has thus been outlined, rather broadly, the more important features of the invention in order that the detailed description thereof may be better understood and in order that the present contribution to the art may be better appreciated. There are additional features of the invention that will be described herein under.

In this respect, before explaining at least one embodiment of the invention in detail, it is to be understood that the invention is not limited to in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to facilitate identification of human with the use of a Facial Recognition System by generating a 3D facial image from a 2D facial image that will overcome the shortcomings of the prior art devices.

An object of the present invention is to have the process of converting a 2D facial image into 3D and the identification of individuals operating on one electronic device.

Another object of the present invention is to have the process of converting a 2D facial image into 3D and the identification of individuals operating on multiple electronic devices.

Another object of the present invention is to facilitate 3D identification of individuals in one location from a 2D facial image located in another separate physical location.

Another object of the present invention is to link multiple electronic devices to a single repository of data (database) for identification of individuals in multiple locations.

Another object of the present invention is to have identification of individuals from a 2D facial image that has been converted into 3D operating on single microprocessor electronic devices and or multi-processor electronic devices, either in a single location or in multiple locations.

Another object of the invention is to broaden the recognition of individuals by manipulating a 3D facial image with a combination of different lighting conditions, shadows, aging, facial hair, weight loss, weight gain and other facial expressions who may present to the Facial Recognition System.

Another object of the present invention is to facilitate identification of individuals from a 2D facial image converted into 3D that does not interfere with the normal operation of the electronic device.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block view of the present invention as a standalone, single or multi-processor electronic device performing 2D to 3D (Facial) Image Conversion, the 3D (Facial) Image Processing and the Facial Recognition.

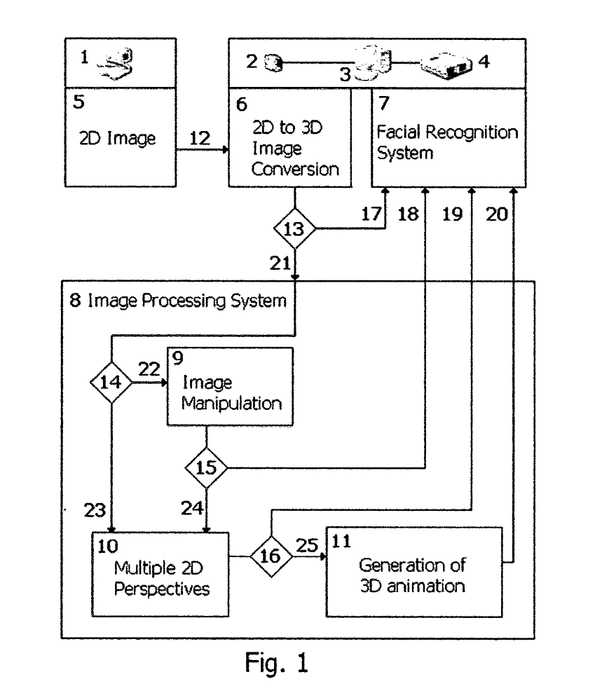

FIG. 2 is a block view of the present invention where one single or multi-processor electronic device is performing 2D to 3D Image Conversion and the 3D Image Processing and one single or multi-processor electronic device is performing Facial recognition.

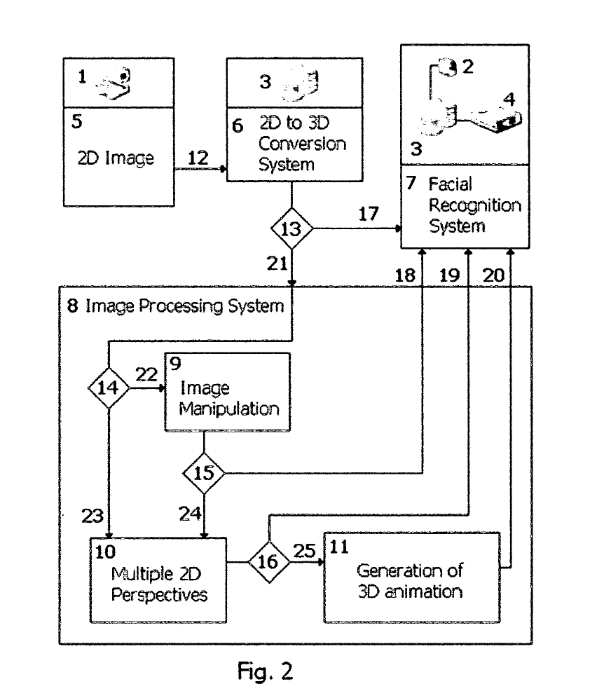

FIG. 3 is a block view of the present invention where one, single or multi-processor electronic device is performing 2D to 3D Image Conversion and one single or multi-processor electronic device is performing the 3D Image Processing and Facial recognition.

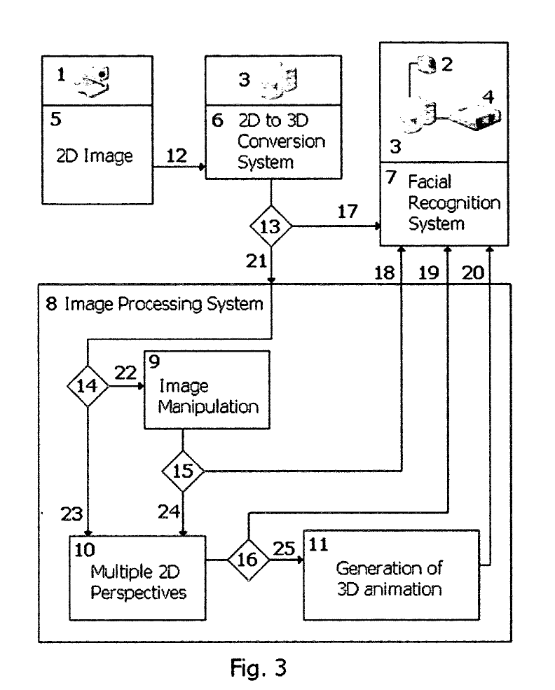

FIG. 4 is a block view of the present invention where one, single or multi-processor electronic device is performing 2D to 3D Image Conversion, one single or multi-processor electronic device is performing the 3D Image Processing and one single or multi-processor electronic device is performing Facial recognition.

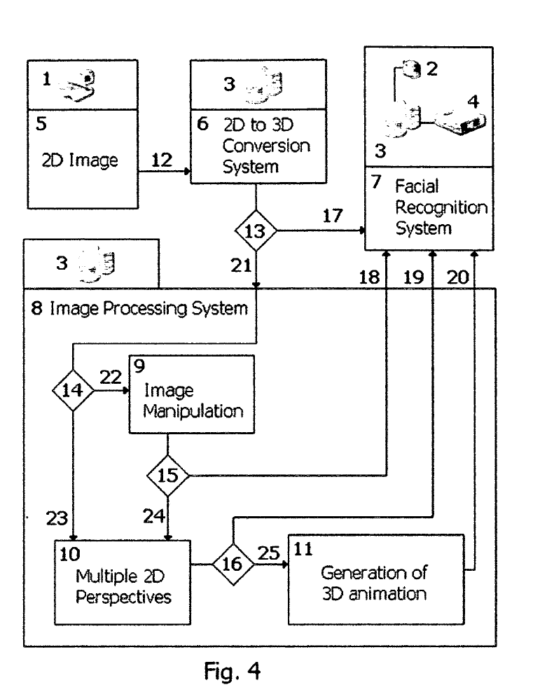

FIG. 5 a block view of the present invention where one, single or multi-processor electronic device is performing 2D to 3D Image Conversion, one single or multi-processor electronic device is performing the 3D Image Processing and one single or multi-processor electronic device is performing Facial recognition, either in the same or different locations and are connected to other single or multi-processor electronic devices which are in turn capable of 2D to 3D Image Conversion, 3D Image Processing and Facial Recognition either in the same or different locations.

FIG. 6 is a block view of the present invention where a standalone, single or multi-processor electronic device performs 2D to 3D Image Conversion, 3D Image Processing and Facial Recognition and is connected to multiple, single or multi-processor electronic devices that perform the Facial Recognition process only.

FIG. 7 is a block view of the present invention where one, single or multi-processor electronic device is performing 2D to 3D Image Conversion, one single or multi-processor electronic device is performing the 3D Image Processing and one single or multi-processor electronic device is performing Facial recognition either in the same or different locations and are connected to other, single or multi-processor electronic devices that perform the Facial Recognition process only.

### DETAILED DESCRIPTION OF THE INVENTION

Turning now descriptively to the drawings, in which similar reference characters denote similar elements throughout the several views, the attached figures illustrate a 2D to 3D Facial Recognition System, which comprises of single or multi-processor electronic devices (3), a database (4), a camera (2), 2D to 3D (Facial) Image Conversion System (6), Facial Recognition System (7) and 3D (Facial) Image Processing System (8).

The 2D Facial image (5) can exist as a photograph, a 2D image in electronic format, or an image taken and or stored by a digital camera which contains a human face. The electronic device (3) can be any single or multi-processor machine capable of performing the process, storing and retrieving data as well as transmitting an electronic message. The 2D image to 3D conversion system (6) must be capable converting a 2D image of a human face into 3D. The Facial Recognition System (7) must be capable of recognizing a human face after accepting a series of two dimensional images, accepting a moving electronic representation of the generated 3D image or accepting the generated 3D image itself. In all instances the images are the bases of enrollment of the individual into the Facial Recognition System (7).

The method consists of taking the generated 3D image of human face (6) and presenting it electronically to the Facial Recognition System (7) so as to simulate as if the person in the original 2D image (5) had stood in front of a camera (2). To achieve this, the Facial Recognition System (7) may be presented with images in a variety of ways.

The 2D image (5) can be in digital picture format either, but not limited to, JPEG, GIF, TIFF, or Bitmap. The 2D image (5) may already be in digital picture format, either stored in an electronic device, on electronic media or stored on a digital camera (1). If the existing image is a photograph, it can be converted to digital picture format through the use of a scanner (1).

Once the 2D digital image of a face (5) is transferred (12) to the 2D to 3D conversion system (6) a 3D image of a human face is created.

If (13) the Facial Recognition System (7) accepts a 3D image it is transferred (17) to the Facial Recognition System (7).

If (13) the Facial Recognition System (7) does not accept a 3D image or

If (13) the 3D image needs a combination of lighting conditions, shadows, aging, facial hair, weight loss, weight gain, eyeglasses and other facial expressions to be simulated, the 3D image is transferred (21) to the Image Processing system (8).

If (14) a combination of lighting conditions, shadows, aging, facial hair, weight loss, weight gain, eyeglasses and other facial expressions are to be simulated, the 3D image is transferred (22) to an Image Manipulation process (9) which performs the desired combination.

If (15) the Facial Recognition System (7) can accept 3D images, the image or images are transferred (18) to the Facial Recognition System (7).

If (15) the Facial Recognition System (7) can not accept 3D images, the 3D image or images are transferred (24) to a process (10) where multiple 2D perspectives of the 3D image or images are generated.

If (16) the Facial Recognition System (7) can accept multiple 2D images, the images are transferred (19) to the Facial Recognition System.

If (16) Facial Recognition System (7) can not accept multiple 2D images, the images are transferred (25) to a process where they are converted into a animated 3D image (11) either, but not limited to, MPEG, AVI or animated GIF. The animated 3D image is presented electronically to the Facial Recognition System (7) internally or through an external electronic feed (20), so as to simulate as if the person in the original 2D image (5) had stood in front of a camera (2).

If (14) a combination of lighting conditions, shadows, aging, facial hair, weight loss, weight gain, eyeglasses and other facial expressions are not to be simulated, the 3D image is transferred (23) to a process (10) where multiple 2D perspectives of the 3D image are generated.

If (16) the Facial Recognition System (7) can accept multiple 2D images, the images are transferred (19) to the Facial Recognition System.

If (16) Facial Recognition System (7) can not accept multiple 2D images, the images are transferred (25) to a process where they are converted into a animated 3D image (11) either, but not limited to, MPEG, AVI or animated GIF. The moving electronic presentation is presented (20) electronically to the Facial Recognition System (7), so as to simulate as if the person in the original 2D image (5) had stood in front of a camera (2).

The Facial Recognition System (7) running on a single or multi-processor electronic device (3) then converts the images into, but not limited to, an algorithm or any mathematical identifier that identifies the individual in the original 2D image (5) and stores the said individual's unique mathematical identifier into its database (4). Once the Facial Recognition System has the individual in its database (4) the single or multi-processor electronic device (3) it is now capable of identifying the individual in the 2D image (5) through the use of a camera (2).

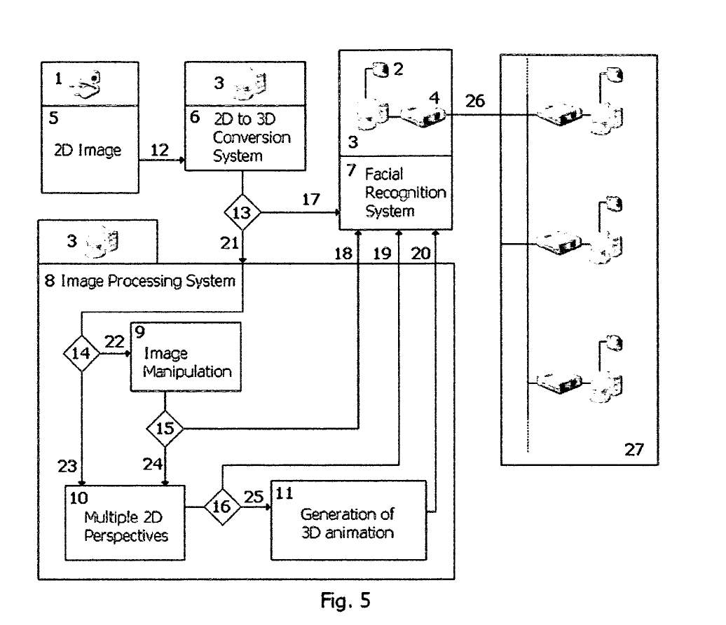

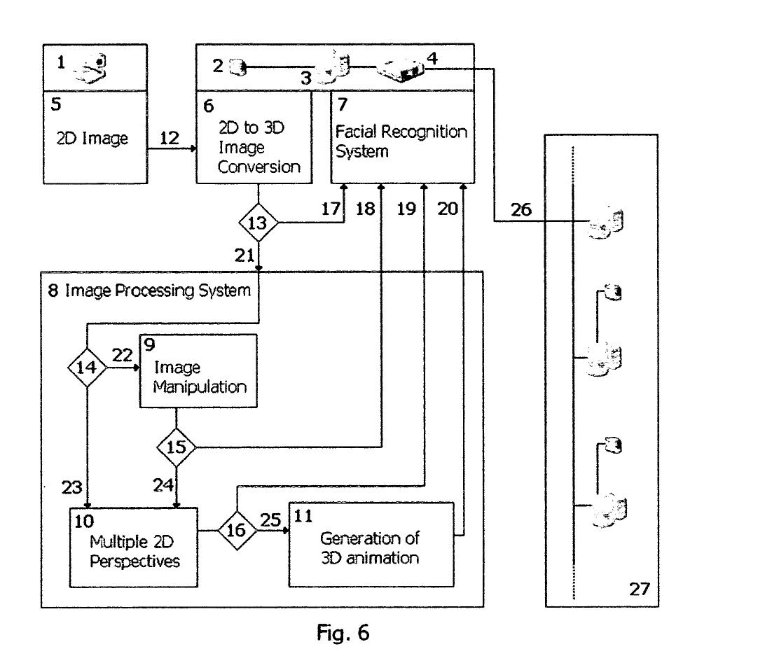

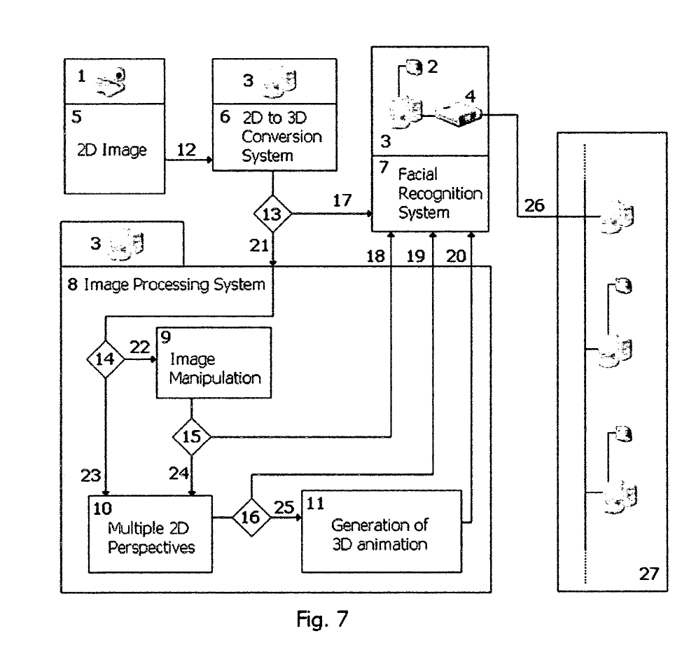

Further in FIG. 5, FIG. 6 and FIG. 7, the database (4) can be accessed (26) by multiple electronic devices (27) either locally or in separate locations, who may or may not have a camera (2) and more specifically in FIG. 5, the database (4) shared with other databases either locally or in separate locations.

Other electronic hardware such as, but not limited to, different types of storage media, networking hardware and electronic peripherals have not been illustrated for the purpose of simplicity.

As to a further discussion of the manner of usage and operation of the present invention, the same should be apparent from the above description. Accordingly, no further discussion relating to the manner of usage and operation will be provided.

With respect to the above description then, it is to be realized that the relationships for the parts of the invention, to include variations in materials, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principals of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for recognizing human faces by converting a 2D facial image into a 3D facial image which comprises of:
a) An electronic device capable of executing machine code such as, but not limited to, a computer.
b) A 2D to 3D Image Conversion System capable of converting a 2-Dimensional image of a human face, into 3-Dimensions.
c) A Facial Recognition System capable of recognizing human faces from multiple angles on the x, y and z axes.
d) A 3D Image Processing System capable of simulating a combination of different lighting environments, facial shadows, facial hair, weight gain, weight loss, aging, eyeglasses and different facial expressions.
e) A camera

2. A system for recognizing human faces in claim 1 where the 2D facial image contains a face.

3. A system for recognizing human faces in claim 1 where one or more electronic devices perform the process.

4. A system for recognizing human faces in claim 1 where the 2D to 3D Image Conversion System uses one or more 2D images to generate the 3D image.

5. A system for recognizing human faces in claim 1 where the camera may be:
a) Concealed
b) Visible
c) Close proximity
d) Long range
e) In a single location
f) In multiple locations
g) 2D
h) 3D
i) Video
j) Still

6. A system for recognizing human faces in claim 1 where one camera may be connected to one Facial Recognition System.

7. A system for recognizing human faces in claim 1 where multiple cameras may be connected to one Facial Recognition System.

8. A system for recognizing human faces in claim 1 where multiple cameras may be connected to multiple Facial Recognition Systems.

9. A system for recognizing human faces in claim 1 where the Facial Recognition System utilizes a series of 2D images of a face to create a unique mathematical value that is used as the basis of identifying an individual (enrollment).

10. A system for recognizing human faces in claim 1 where the Facial Recognition System utilizes a 3D image of a face to create a unique mathematical value that is used as the basis of identifying an individual.

11. A process by which a 2D image of a human face is converted into a 3D image and the 3D image is used by a Facial Recognition System to later identify the individual in the original 2D image from multiple angles.

12. A process by which a 2D image of a human face is converted into a 3D image and the 3D image is used to create multiple 2D images that are used by a Facial Recognition System to later identify the individual in the original 2D image from multiple angles.

13. A process by which a 2D image of a human face is converted into a 3D image and the 3D image is processed to simulate combinations of different lighting environments, facial shadows, facial hair, weight gain, weight loss, aging, eyeglasses and different facial expression and the generated 3D images are used by a Facial Recognition System to later identify the individual in the original 2D image from multiple angles.

14. A process by which a 3D image of a human face in claim 12 is used to create multiple 2D images that are used by a Facial Recognition System to later identify the said individual from multiple angles.
